(19) United States
(12) Patent Application Publication
(10) Pub. No.: US 2019/0300296 A1
(43) Pub. Date: Oct. 3, 2019

(54) METHODS AND APPARATUS FOR SECURING AN ARTICLE

(71) Applicant: CORNING INCORPORATED, CORNING, NY (US)

(72) Inventors: Daniel Robert Boughton, Naples, NY (US); James Gerard Fagan, Painted Post, NY (US); Thomas Augustus Keebler, Corning, NY (US)

(21) Appl. No.: 16/344,678

(22) PCT Filed: Oct. 24, 2017
(86) PCT No.: PCT/US17/58002

§ 371 Date: Apr. 24, 2019

Related U.S. Application Data
(60) Provisional application No. 62/413,655, filed on Oct. 27, 2016.

(51) Int. Cl. B65G 49/06; C03C 17/00

(52) U.S. Cl. CPC B65G 49/061; C03C 2217/78; C03C 17/002

(57) ABSTRACT

A carrier apparatus including a base including a plurality of peripheral portions, each peripheral portion including an inner surface facing an inner direction, at least one peripheral portion selectively moveable between an extended position and a retracted position, and an elastic member to bias the at least one peripheral portion into the retracted position such that the inner surfaces of the peripheral portions of the plurality of peripheral portions cooperate to circumscribe a retaining area. The carrier apparatus may include an article disposed in the retaining area. A fixture including a cavity for receiving the carrier apparatus may be provided. Methods of using, processing, and assembling the carrier apparatus may also be provided.

### CROSS-REFERENCE TO RELATED APPLICATIONS

This application claims the benefit of priority under 35 U.S.C. § 119 of U.S. Provisional Application Ser. No. 62/413655 filed on Oct. 27, 2016, the content of which is relied upon and incorporated herein by reference in its entirety.

### FIELD

The present disclosure relates generally to methods and apparatus for securing an article and, more particularly, to methods and apparatus for securing an article while isolating at least a portion of an edge of the article.

### BACKGROUND

Glass sheets are commonly used, for example, in display applications, for example liquid crystal displays (LCDs), electrophoretic displays (EPD), organic light emitting diode displays (OLEDs), plasma display panels (PDPs), or the like. Glass sheets are commonly fabricated by flowing molten glass to a forming body whereby a glass ribbon may be formed by a variety of ribbon forming processes, for example, slot draw, float, down-draw, fusion down-draw, rolling, or up-draw. The glass ribbon may then be subsequently divided to provide sheet glass suitable for further processing into a desired display application including, but not limited to, a screen or cover glass for mobile devices, wearables (e.g., watches), televisions, computers, tablets, and other display monitors.

There is a demand for high quality glass sheets that include a material deposited on a major surface of the glass sheet to, for example, provide at least one of an abrasion and scratch resistant coating on the glass sheet and increase a strength of the glass sheet to prevent breakage of the glass sheet. The demand extends to glass sheets including planar (e.g., 2D) portions as well as to glass sheets including non-planar (e.g., 3D) portions. Some processes of depositing a material on the glass sheet include handling and transport of the glass sheet. For example, some glass coating deposition technologies include at least one of physical, plasma, and chemical vapor deposition that provides a coating on the glass sheet as the glass sheet is handled and transported during the coating deposition process. The coatings may be optically transparent so as to provide minimal to no interference with or distortion of images that may be displayed on or viewed through the glass sheet. Other techniques may provide a sapphire cover glass to protect the glass sheet from scratches; however, a surface coating provided by depositing a material on the glass sheet that prevents abrasions and scratches on the glass sheet and increases a strength of the glass sheet may provide a more efficient and less expensive glass sheet than, for example, a sapphire cover glass and may, therefore, be employed in a variety of display applications with significant cost savings.

Glass articles, for example cover glass, including, in some embodiments, cover glass for a mobile phone, may be manufactured with one or more surface treatments to enhance its functions and provide a positive experience for an end user. For example, cover glass may be coated with one or more coating layers to provide desired characteristics. Such coating layers may include anti-reflection coating layers, easy-to-clean coating layers, and scratch resistant coating layers. These coating layers may be applied on a surface of the cover glass using various vacuum deposition methods for example sputtering, plasma vapor deposition (PVD), chemical vapor deposition (CVD), and plasma-enhanced chemical vapor deposition (PECVD). These coating layers may be applied to an entire surface of the cover glass (e.g., an edge-to-edge coating of a cover glass surface). In some embodiments, a pressure sensitive adhesive (e.g., double-sided Kapton tape) may be used to hold the cover glass on a support plate during a coating process.

Moreover, during a coating process, it may be desirable that the material deposited on the glass sheet is deposited only on, for example, the major surface with which a user may interact. For example, a glass sheet may be provided in a touch-screen application where a user may physically contact the glass sheet to control features of a display device. Likewise, a glass sheet may be provided in an application where a major surface of the glass is provided for viewing by a user and is, therefore, exposed to the environment including dust, debris, and other objects that may scratch and abrade the surface of the glass. Thus, there is a desire for a carrier apparatus to secure a glass sheet and facilitate handling and transport of the glass sheet during processing in a manner that exposes an exposed area of the major surface of the glass sheet to be coated while isolating the edge of the glass sheet and the opposing major surface of the glass sheet.

### SUMMARY

There are set forth exemplary embodiments of a carrier apparatus including an article to secure the article and facilitate handling and transport of the article during processing in a manner that exposes an exposed area of the major surface of the article to be coated while isolating the edge of the article and the opposing major surface of the article. Additionally, a fixture including a cavity to receive one or more carrier apparatus is provided. Methods of using the carrier apparatus, including methods of assembling the carrier apparatus and methods of processing the carrier apparatus, are also provided.

Some exemplary embodiments of the disclosure are described below with the understanding that any of the embodiments, including any one or more features of the various embodiments, may be used alone or in combination with one another.

### Embodiment 1

A carrier apparatus includes a base including a plurality of peripheral portions, each peripheral portion of the plurality of peripheral portions includes an inner surface facing an inner direction, and at least one peripheral portion of the plurality of peripheral portions is selectively moveable between an extended position and a retracted position. The carrier apparatus includes an elastic member to bias the at least one peripheral portion of the plurality of peripheral portions into the retracted position such that the inner surfaces of the plurality of peripheral portions cooperate to circumscribe a retaining area.

### Embodiment 2

The carrier apparatus of embodiment 1, where the elastic member includes an endless loop.

### Embodiment 3

The carrier apparatus of any one or more of embodiments 1 and 2, at least one peripheral portion of the plurality of peripheral portions includes a support surface extending from the inner surface in the inner direction.

### Embodiment 4

The carrier apparatus of any one or more of embodiments 1-3, each peripheral portion of the plurality of peripheral portions includes a first engagement surface and a second engagement surface, the first engagement surface and the second engagement surface of each peripheral portion of the plurality of peripheral portions engage a corresponding engagement surface of an adjacent peripheral portion of the plurality of peripheral portions when the plurality of peripheral portions are in the retracted position.

### Embodiment 5

The carrier apparatus of any one or more of embodiments 1-4, at least one peripheral portion of the plurality of peripheral portions includes an outer surface, and the elastic member engages the outer surface of the at least one peripheral portion of the plurality of peripheral portions.

### Embodiment 6

The carrier apparatus of embodiment 5, each peripheral portion of the plurality of peripheral portions includes an outer surface, and the elastic member simultaneously engages the outer surface of each peripheral portion of the plurality of peripheral portions, the outer surface of each peripheral portion of the plurality of peripheral portions includes a groove, and the elastic member is seated within the groove of each peripheral portion of the plurality of peripheral portions.

### Embodiment 7

A fixture includes a cavity to receive the carrier apparatus of any one or more of embodiments 1-6. In some embodiments, an inner peripheral surface of the cavity of the fixture compresses the elastic member to secure the carrier apparatus to the fixture.

### Embodiment 8

The carrier apparatus of embodiment 1 includes an article disposed in the retaining area. In some embodiments, the article includes a first major surface, a second major surface, a thickness between the first major surface and the second major surface, and an edge extending across the thickness between the first major surface and the second major surface. In some embodiments, in the retracted position, the inner surfaces of the plurality of peripheral portions cooperate to circumscribe the edge of the article.

### Embodiment 9

The carrier apparatus of embodiment 8, at least one peripheral portion of the plurality of peripheral portions includes a support surface extending from the inner surface in the inner direction, and the support surface of the at least one peripheral portion of the plurality of peripheral portions supports the first major surface of the article.

### Embodiment 10

The carrier apparatus of any one or more of embodiments 8 and 9, the article is disposed in the retaining area with at least a portion of the second major surface of the article exposed for a processing technique.

### Embodiment 11

The carrier apparatus of embodiment 10, the article is disposed in the retaining area with at least a portion of the edge of the article isolated from the exposed portion of the second major surface of the article.

### Embodiment 12

The carrier apparatus of any one or more of embodiments 10 and 11, the article disposed in the retaining area with at least a portion of the second major surface of the article isolated from the exposed portion of the second major surface of the article.

### Embodiment 13

The carrier apparatus of any one or more of embodiments 8-12 includes an adapter ring positioned between the inner surface of at least one peripheral portion of the plurality of peripheral portions and the edge of the article.

### Embodiment 14

The carrier apparatus of any one or more of embodiments 8-13, the elastic member biases at least one peripheral portion of the plurality of peripheral portions into the retracted position, and the plurality of peripheral portions cooperate to hold the article.

### Embodiment 15

The carrier apparatus of any one or more of embodiments 8-14, the article includes a sheet including glass, glass-ceramic, ceramic, or combinations thereof

### Embodiment 16

A fixture including a cavity receives the carrier apparatus of any one or more of embodiments 8-15. In some embodiments, an inner peripheral surface of the cavity of the fixture compresses the elastic member to secure the carrier apparatus to the fixture.

### Embodiment 17

A method of using the carrier apparatus of any one or more of embodiments 8-16 includes processing an exposed area of the second major surface of the article while the article is disposed in the retaining area.

### Embodiment 18

A method of using a carrier apparatus includes applying a retracting force to at least one of a plurality of peripheral portions of a base to bias the at least one peripheral portion of the plurality of peripheral portions into a retracted position with an inner surface of each peripheral portion of the plurality of peripheral portions cooperating to circumscribe a retaining area including an opening into the retaining area. In some embodiments, the method includes opposing the retracting force of at least one peripheral portion of the plurality of peripheral portions to move the at least one peripheral portion into an extended position to enlarge the opening into the retaining area.

### Embodiment 19

The method of embodiment 18 includes engaging the base with a tool to oppose the retracting force and move the at least one peripheral portion into the extended position.

### Embodiment 20

The method of any one or more of embodiments 18 and 19 includes placing an article within the enlarged opening while opposing the retracting force. The article includes a first major surface, a second major surface, a thickness between the first major surface and the second major surface, and an edge extending across the thickness between the first major surface and the second major surface.

### Embodiment 21

The method of embodiment 20, after placing the article, the method includes ceasing to oppose the retracting force such that the at least one peripheral portion of the plurality of peripheral portions moves into the retracted position, thereby securing the article within the retaining area.

### Embodiment 22

The method of embodiment 21 includes processing an exposed area of the second major surface of the article while the article is secured within the retaining area.

### Embodiment 23

After processing the exposed area of the second major surface of the article, the method of embodiment 22 includes enlarging the opening into the retaining area, and then removing the article from the enlarged opening.

### Embodiment 24

The method of any one or more of embodiments 20-23, the article includes a sheet including glass, glass-ceramic, ceramic, or combinations thereof.

### BRIEF DESCRIPTION OF THE DRAWINGS

The above and other features and advantages of embodiments of the present disclosure are better understood when the following detailed description is read with reference to the accompanying drawings, in which:

FIG. 1 illustrates an exploded perspective view of an exemplary carrier apparatus including an article in accordance with embodiments of the disclosure;

FIG. 2 illustrates an assembled perspective view of the exemplary carrier apparatus of FIG. 1 in accordance with embodiments of the disclosure including a retaining area in which the article may be disposed;

FIG. 3 shows a top view of the assembled exemplary carrier apparatus of FIG. 2 provided in a retracted position with the article disposed in a retaining area in accordance with embodiments of the disclosure;

FIG. 4 shows an alternate top view of the assembled exemplary carrier apparatus of FIG. 2 provided in an extended position with the article removed from the retaining area in accordance with embodiments of the disclosure;

FIG. 5 illustrates a fixture including a cavity receiving one or more carrier apparatus including an article in accordance with embodiments of the disclosure;

FIG. 6 shows a cross-sectional view of the fixture including the carrier apparatus and the article along line 6-6 of FIG. 5 with the carrier apparatus separated from the fixture in accordance with embodiments of the disclosure;

FIG. 7 illustrates an alternate cross-sectional view of the fixture including the carrier apparatus and the article along line 6-6 of FIG. 5 with the carrier apparatus partially received in the cavity of the fixture in accordance with embodiments of the disclosure;

FIG. 8 illustrates another alternate cross-sectional view of the fixture including the carrier apparatus and the article along line 6-6 of FIG. 5 with the carrier apparatus received in the cavity of the fixture in accordance with embodiments of the disclosure;

FIG. 9 shows an enlarged view of a portion of the cross-sectional view of the fixture including the carrier apparatus and the article taken at view 9 of FIG. 8 in accordance with embodiments of the disclosure;

FIG. 10 illustrates a flowchart of methods of processing a carrier apparatus in accordance with embodiments of the disclosure; and

FIG. 11 illustrates a top view of an exemplary method of processing a carrier apparatus including fixing the carrier apparatus to a rotatable drum in accordance with embodiments of the disclosure.

### DETAILED DESCRIPTION

Embodiments will now be described more fully hereinafter with reference to the accompanying drawings in which exemplary embodiments are shown. Whenever possible, the same reference numerals are used throughout the drawings to refer to the same or like parts. However, claims may encompass many different aspects of various embodiments and should not be construed as limited to the embodiments set forth herein.

As briefly indicated above, in various embodiments there are provided methods and apparatus for supporting an article. Embodiments of articles may include silicon wafers, ceramic sheets, glass-ceramic sheets, and glass sheets. In some embodiments, the article may include a sheet of glass such as a sheet containing glass or a sheet substantially or entirely fabricated from glass. The glass, if provided, may include a wide variety of glass compositions including, but not limited to, soda-lime glass, aluminosilicate glass, borosilicate glass, alumino-borosilicate glass, an alkali-containing glass, or an alkali-free glass. For purposes of the disclosure, the term “glass” is meant to include any material made at least partially of glass, including glass and glass-ceramics. “Glass-ceramics” include materials produced through controlled crystallization of glass. In some embodiments, glass-ceramics have about 30% to about 90% crystallinity. Non-limiting examples of glass ceramic systems that may be used include Li₂O×Al₂O₃×nSiO₂ (i.e. LAS system), MgO×Al₂O₃×nSiO₂ (i.e. MAS system), and ZnO×Al₂O₃×nSiO₂ (i.e. ZAS system). Features of the carrier apparatus discussed below will be described with reference to one or more glass sheets that may be incorporated as part of the carrier apparatus with the understanding that, unless otherwise noted, articles other than glass sheets may likewise be incorporated as part of the carrier apparatus.

Manufacturers of glass sheets (e.g., for use in liquid crystal displays “LCDs,” electrophoretic displays “EPD,” organic light emitting diode displays “OLEDs,” plasma display panels “PDPs”) often heat treat and/or chemically strengthen the glass sheets to improve or modify their properties. In some embodiments, a device is provided for supporting an article (e.g., a glass sheet) during processing. As may be appreciated, a glass sheet according to various embodiments may include one or more edges. For example, a glass sheet may be provided that has four edges and a generally square, rectangular, trapezoidal, parallelogram or other shape. In some embodiments, a round, oblong, or elliptical glass sheet may be provided that has one continuous edge. Other glass sheets having two, three, five, etc. edges may also be provided and are contemplated as being within the scope of the disclosure. Glass sheets of various sizes, including varying lengths, heights, and thicknesses, are also contemplated within the scope of the disclosure. In some embodiments, a nominal thickness (i.e., the thickness “t” discussed below and illustrated in the figures) of a central portion of the glass sheet may be less than or equal to about 3 mm, for example, from about 30 μm to about 3 mm, from about 30 μm to about 2 mm, from about 30 μm to about 1.5 mm, from about 30 μm to about 1 mm, from about 30 μm to about 750 μm, from about 30 μm to about 500 μm, from about 30 μm to about 400 μm, from about 30 μm to about 300 μm, from about 30 μm to about 200 μm, from about 30 μm to about 100 μm, from about 30 μm to about 50 μm, and all ranges and subranges of thicknesses therebetween.

The glass articles, including coating layers, may be used as a cover glass, for example, and may serve to, among other things, reduce undesired reflections, prevent formation of mechanical defects in the glass (e.g., scratches or cracks), and/or provide an easy to clean transparent surface. The glass articles disclosed herein may be incorporated into another article such as an article with a display (or display articles) (e.g., consumer electronic products, including mobile phones, tablets, computers, navigation systems, wearable devices (e.g., watches) and the like), architectural articles, transportation articles (e.g., automotive, trains, aircraft, sea craft, etc.), appliance articles, or any article that requires some transparency, scratch-resistance, abrasion resistance or a combination thereof. An exemplary article incorporating any of the glass articles disclosed herein is a consumer electronic device including a housing having front, back, and side surfaces; electrical components that are at least partially inside or entirely within the housing and including at least a controller, a memory, and a display at or adjacent to the front surface of the housing; and a cover substrate at or over the front surface of the housing such that it is over the display. In some embodiments, the cover substrate may include any of the glass articles disclosed herein. In some embodiments, at least one of a portion of the housing or the cover glass may include the glass articles disclosed herein.

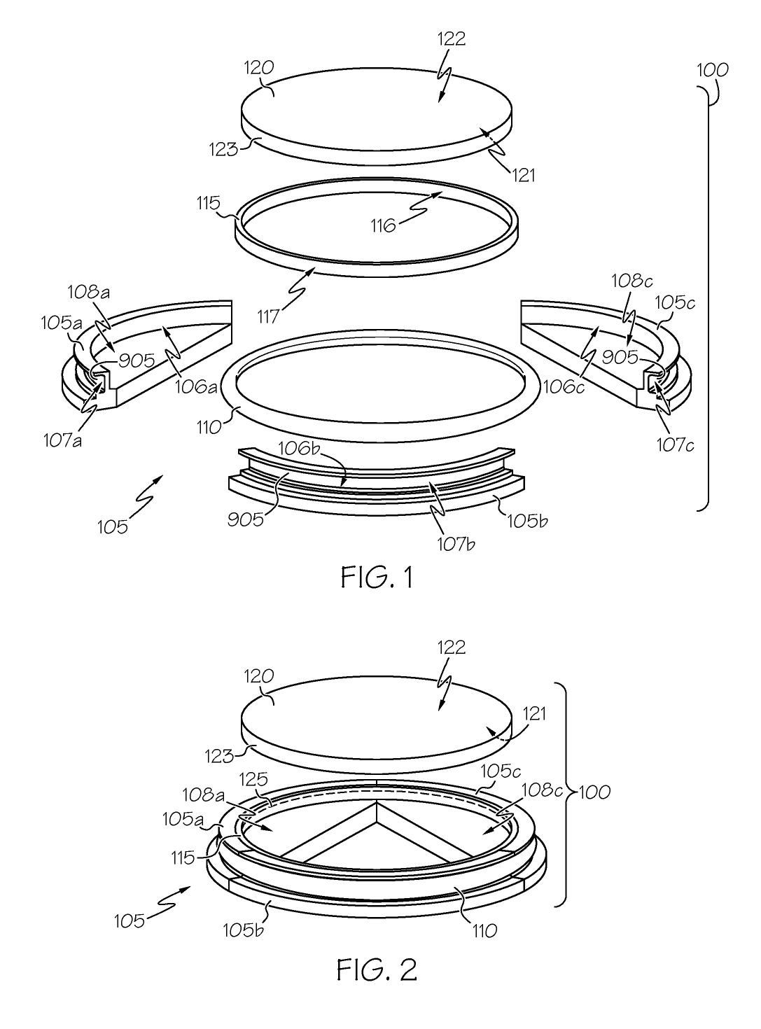

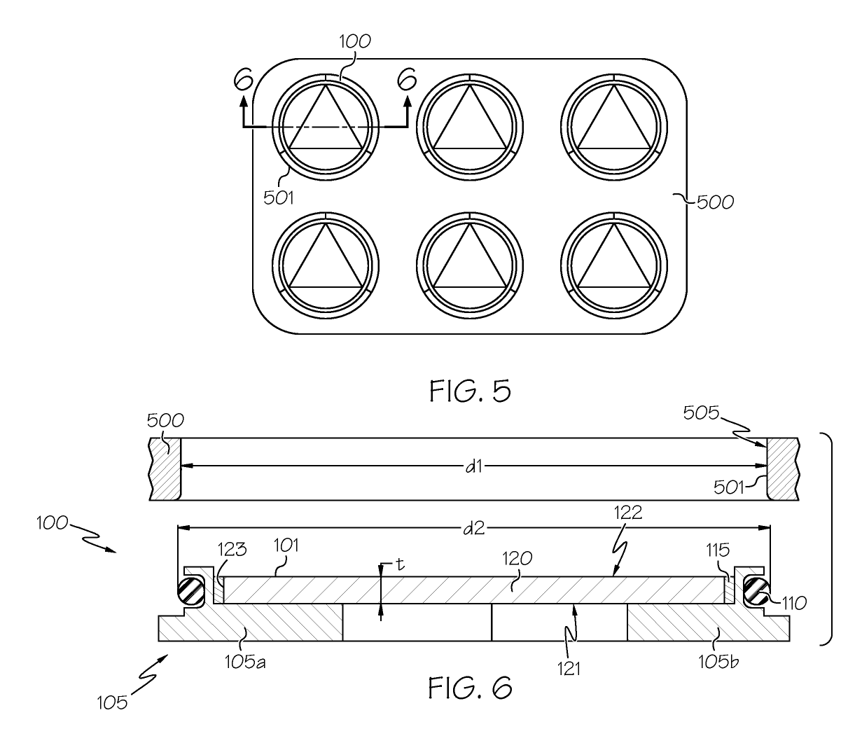

The present disclosure provides methods and apparatus for securing one or more articles, including but not limited to, a sheet including glass, glass-ceramic, ceramic, or combinations thereof. For example, FIGS. 1-4 illustrate exemplary features of a carrier apparatus 100, and FIGS. 5-9 illustrate exemplary features of a fixture 500 for receiving one or more of the carrier apparatus 100. As shown, the carrier apparatus 100 may include an article (e.g., the illustrated glass sheet 120); however, in some embodiments, the carrier apparatus 100 may be provided without the article. For example, the carrier apparatus 100 may be provided without the illustrated glass sheet 120, where the carrier apparatus 100 may be considered complete without the glass sheet 120. Accordingly, in some embodiments, the carrier apparatus 100 may later be provided with an article for incorporation as part of the carrier apparatus 100. Throughout the disclosure, features of the disclosure will be described with reference to the glass sheet 120 illustrated in the drawings with the understanding that such features may equally apply to articles other than a glass sheet.

FIG. 1 illustrates an exploded perspective view of the exemplary carrier apparatus 100 in accordance with embodiments of the disclosure. In some embodiments, the carrier apparatus 100 may include a glass sheet 120 including a first major surface 121, a second major surface 122, a thickness “t” (shown in FIGS. 6-8) between the first major surface 121 and the second major surface 122, and an edge 123 extending across the thickness “t” between the first major surface 121 and the second major surface 122. In some embodiments, the edge 123 of the glass sheet 120 may include a planar edge surface extending across at least a portion of the thickness “t” between the first major surface 121 and the second major surface 122. For example, in some embodiments, the edge 123 may include a surface that when viewed relative to a cross-section taken perpendicular to at least one of the first major surface 121 and the second major surface 122 appears as a locally flat edge surface extending across at least a portion of the thickness “t” between the first major surface 121 and the second major surface 122. Likewise, that same edge surface when viewed, for example, facing at least one of the first major surface 121 and the second major surface 122 forms a circular cylinder (e.g., the entire edge surface circumscribes the first major surface 121 and the second major surface 122 to form a circular cylinder). Moreover, in some embodiments, the edge 123 may include a non-planar edge surface (e.g., when viewed relative to a cross-section taken perpendicular to at least one of the first major surface 121 and the second major surface 122) extending across at least a portion the thickness “t” between the first major surface 121 and the second major surface 122. Additionally, in some embodiments, the edge 123 of the glass sheet 120 may include a corner between the planar edge surface and at least one of the first major surface 121 and the second major surface 122. Similarly, in some embodiments, the edge 123 of the glass sheet 120 may include a corner between the non-planar edge surface and at least one of the first major surface 121 and the second major surface 122. In some embodiments, the corner may include a square corner where at least one of the first major surface 121 and the second major surface 122 connects to the planar edge surface at a substantially 90-degree angle. Alternatively, in some embodiments, the corner may include a rounded corner, a cut corner, a chamfered corner, a beveled corner, or other shape corner that connects at least one of the first major surface 121 and the second major surface 122 to the planar edge surface or to the non-planar edge surface. Accordingly, for purposes of the disclosure, irrespective of shape, the edge 123 of the glass sheet 120 may be defined as the surface extending across the thickness “t” of the glass sheet 120 between the first major surface 121 and the second major surface 122 and circumscribing the first major surface 121 and the second major surface 122, thereby forming the outer periphery of the glass sheet 120.

Unless otherwise noted, in some embodiments, the carrier apparatus 100 may be modified, in accordance with features of the disclosure, to include a glass sheet, or other article, having a shape and size different from the illustrated glass sheet 120, without departing from the scope of the disclosure. Furthermore, in some embodiments, the carrier apparatus 100 may include a glass sheet, or other article, with the first major surface 121 and/or the second major surface 122 including at least one of a planar portion and a non-planar portion, without departing from the scope of the disclosure.

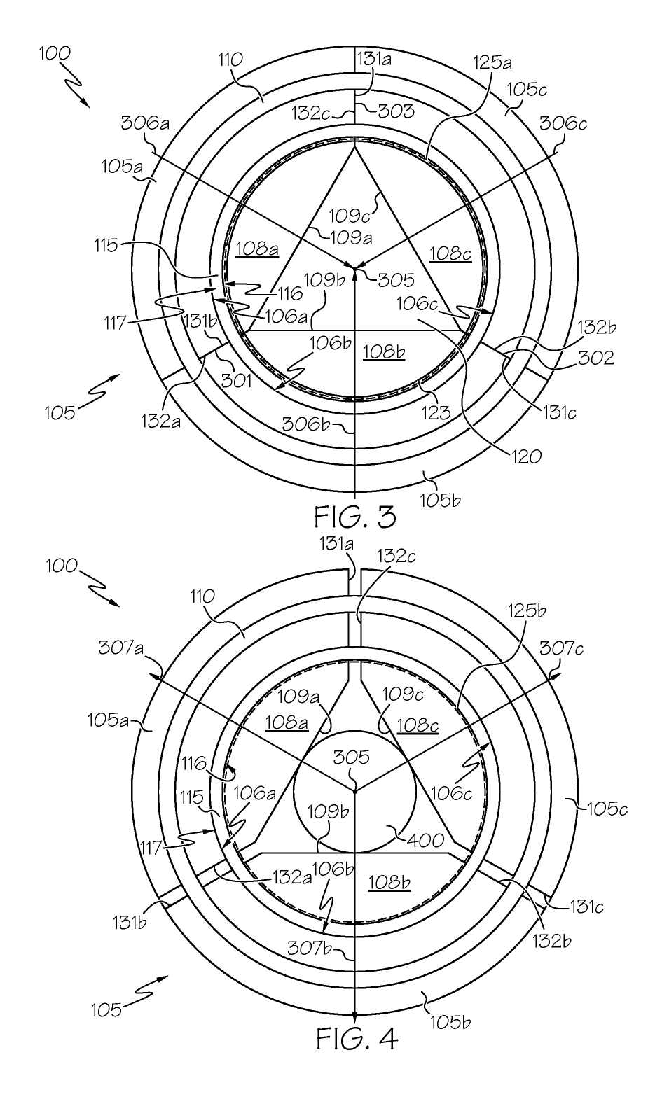

As further illustrated in FIG. 1, in some embodiments, the carrier apparatus 100 may include a base 105 including a plurality of peripheral portions 105a, 105b, 105c. Although illustrated as including three peripheral portions (e.g., a first peripheral portion 105a, a second peripheral portion 105b, and a third peripheral portion 105c), unless otherwise noted, the number of peripheral portions 105a, 105b, 105c is not intended to limit the scope of the disclosure. Accordingly, in some embodiments, the base 105 of the carrier apparatus 100 may include two, three, four, or more peripheral portions without departing from the scope of the disclosure. In some embodiments, at least one (e.g., one, more than one, each) peripheral portion of the plurality of peripheral portions 105a, 105b, 105c may be selectively moveable between an extended position (shown in FIG. 4) and a retracted position (shown in FIG. 3). For example, with reference to FIG. 3, in some embodiments, one or more peripheral portions of the plurality of peripheral portions 105a, 105b, 105c may be selectively moveable in a direction 306a, 306b, 306c toward a centroid 305 of the plurality of peripheral portions 105a, 105b, 105c. In some embodiments, the centroid 305 may correspond to the geometric center of the plurality of peripheral portions 105a, 105b, 105c, and one or more peripheral portions of the plurality of peripheral portions 105a, 105b, 105c may be selectively moveable in the direction 306a, 306b, 306c toward the centroid 305 into the retracted position. Likewise, with reference to FIG. 4, in some embodiments, one or more peripheral portions of the plurality of peripheral portions 105a, 105b, 105c may be selectively moveable in a direction 307a, 307b, 307c away from the centroid 305 of the plurality of peripheral portions 105a, 105b, 105c into the extended position.

In some embodiments, each peripheral portion of the plurality of peripheral portions 105a, 105b, 105c may include an inner surface 106a, 106b, 106c, facing an inner direction (e.g., facing toward the centroid 305 along directions 306a, 306b, 306c). In some embodiments (e.g., as shown in FIG. 2), the inner surfaces 106a, 106b, 106c of the plurality of peripheral portions 105a, 105b, 105c may cooperate to partially or completely circumscribe a retaining area 125. Indeed, adjacent ends of the peripheral portions 105a, 105b, 105c may abut one another to provide a combined substantially continuous surface that completely circumscribes the retaining area 125. Although illustrated as circumscribing a circular retaining area 125, unless otherwise noted, in some embodiments, the carrier apparatus 100 may be modified, in accordance with features of the disclosure, to include a retaining area 125 having a shape and size different from the illustrated retaining area 125, without departing from the scope of the disclosure. For example, in some embodiments, the inner surfaces 106a, 106b, 106c, of the plurality of peripheral portions 105a, 105b, 105c may cooperate to partially or completely circumscribe a retaining area 125 having a rectangular shape, an oval shape, a square shape, a trapezoidal shape, a parallelogram shape, or other shape. Additionally, in some embodiments, the glass sheet 120 may be disposed in the retaining area 125; and, in the retracted position, the inner surfaces 106a, 106b, 106c of the plurality of peripheral portions 105a, 105b, 105c may cooperate to partially or completely circumscribe the edge 123 of the glass sheet 120. For example, in some embodiments, in the retracted position, the inner surfaces 106a, 106b, 106c of the plurality of peripheral portions 105a, 105b, 105c may cooperate to partially or entirely circumscribe at least a portion of the edge 123 of the glass sheet 120. As shown in FIG. 3 and FIGS. 5-8, in some embodiments, in the retracted position, the inner surfaces 106a, 106b, 106c of the plurality of peripheral portions 105a, 105b, 105c may cooperate to entirely circumscribe the entire edge 123 of the glass sheet 120. Moreover, in some embodiments, the shape of the retaining area 125 may correspond to the shape of the glass sheet 120. Accordingly, in some embodiments, the carrier apparatus 100 may be modified, in accordance with features of the disclosure, to accommodate glass sheets having a variety of shapes and sizes, without departing from the scope of the disclosure.

In some embodiments, as shown in FIG. 3, each peripheral portion of the plurality of peripheral portions 105a, 105b, 105c may include a first engagement surface 131a, 131b, 131c and a second engagement surface 132a, 132b, 132c. In some embodiments, the first engagement surface 131a, 131b, 131c and the second engagement surface 132a, 132b, 132c of each peripheral portion of the plurality of peripheral portions 105a, 105b, 105c may engage a corresponding engagement surface of an adjacent peripheral portion of the plurality of peripheral portions 105a, 105b, 105c. For example, the first engagement surface 131a of the first peripheral portion 105a may engage the second engagement surface 132c of the third peripheral portion 105c at a third mating location 303 between the first peripheral portion 105a and the third peripheral portion 105c. Additionally, the second engagement surface 132a of the first peripheral portion 105a may engage the first engagement surface 131b of the second peripheral portion 105b at a first mating location 301 between the first peripheral portion 105a and the second peripheral portion 105b. Likewise, the second engagement surface 132b of the second peripheral portion 105b may engage the first engagement surface 131c of the third peripheral portion 105c to at a second mating location 302 between the second peripheral portion 105b and the third peripheral portion 105c. In some embodiment, when the plurality of peripheral portions 105a, 105b, 105c are in the retracted position, the first engagement surface 131a, 131b, 131c and the second engagement surface 132a, 132b, 132c of each peripheral portion of the plurality of peripheral portions 105a, 105b, 105c may engage the corresponding engagement surface of the adjacent peripheral portion of the plurality of peripheral portions 105a, 105b, 105c. However, in some embodiments, when the plurality of peripheral portions 105a, 105b, 105c are in the retracted position and/or when the plurality of peripheral portions 105a, 105b, 105c are in the extended position, the first engagement surface 131a, 131b, 131c and the second engagement surface 132a, 132b, 132c of each peripheral portion of the plurality of peripheral portions 105a, 105b, 105c may not engage a corresponding engagement surface of an adjacent peripheral portion of the plurality of peripheral portions 105a, 105b, 105c.

In some embodiments, as shown in FIG. 1, the carrier apparatus 100 may include an elastic member 110 to bias at least one peripheral portion of the plurality of peripheral portions 105a, 105b, 105c into the retracted position such that the inner surfaces 106a, 106b, 106c of the plurality of peripheral portions 105a, 105b, 105c cooperate to circumscribe the retaining area 125. In some embodiments, the elastic member 110 may include an endless loop. For example, in some embodiments, the elastic member 110 may include one or more of an elastic band, a spring (e.g., coil spring, circular spring, leaf spring, etc.), a clamp, a clip, a bracket, or other structure to provide a force to bias each peripheral portion of the plurality of peripheral portions 105a, 105b, 105c into the retracted position. In some embodiments, the elastic member 110 may bias each peripheral portion of the plurality of peripheral portions 105a, 105b, 105c into the retracted position, and the plurality of peripheral portions 105a, 105b, 105c may cooperate to hold the glass sheet 120. For example, in some embodiments, the elastic member 110 may provide a force to bias the at least one peripheral portion of the plurality of peripheral portions 105a, 105b, 105c in a direction toward the centroid 305 of the plurality of peripheral portions 105a, 105b, 105c. Accordingly, in some embodiments, the elastic member 110 may provide a retracting force laterally in one or more of directions 306a, 306b, 306c toward the centroid 305. Based at least in part on the retracting force provided by the elastic member 110 in one or more of directions 306a, 306b, 306c, one or more peripheral portions of the plurality of peripheral portions 105a, 105b, 105c may thereby exert a corresponding lateral force in one or more of directions 306a, 306b, 306c toward the centroid 305 thereby securing the glass sheet 120 within the retaining area 125 of the carrier apparatus 100. Although illustrated as a circular elastic member 110, unless otherwise noted, in some embodiments, the carrier apparatus 100 may be modified, in accordance with features of the disclosure, to include an elastic member 110 having a shape and size different from the illustrated elastic member 110, without departing from the scope of the disclosure. For example, in some embodiments, the elastic member 110 may include a rectangular shape, an oval shape, a square shape, a trapezoidal shape, a parallelogram shape, or other shape to bias at least one peripheral portion of the plurality of peripheral portions 105a, 105b, 105c into the retracted position.

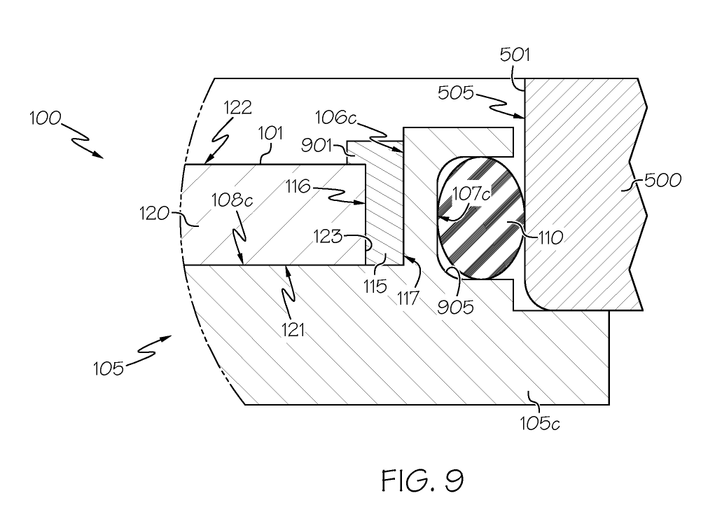

In some embodiments, at least one peripheral portion of the plurality of peripheral portions 105a, 105b, 105c may include an outer surface 107a, 107b, 107c, and the elastic member 110 may engage the outer surface 107a, 107b, 107c of the at least one peripheral portion of the plurality of peripheral portions 105a, 105b, 105c. In some embodiments, each peripheral portion of the plurality of peripheral portions 105a, 105b, 105c may include an outer surface 107a, 107b, 107c, and the elastic member 110 may simultaneously engage the outer surface 107a, 107b, 107c of each peripheral portion of the plurality of peripheral portions 105a, 105b, 105c. For example, in some embodiments, the outer surface 107a, 107b, 107c of each peripheral portion of the plurality of peripheral portions 105a, 105b, 105c may include a groove 905 (shown in FIG. 1 and FIG. 9), and the elastic member 110 may be seated within the groove 905 (see FIG. 9) of each peripheral portion of the plurality of peripheral portions 105a, 105b, 105c. By simultaneously engaging the outer surface 107a, 107b, 107c of each peripheral portion of the plurality of peripheral portions 105a, 105b, 105c, the elastic member 110 may bias each peripheral portion of the plurality of peripheral portions 105a, 105b, 105c into the retracted position. In some embodiments, for example, depending on the force desired to secure the glass sheet 120 to within the retaining area 125 of the base 105, the elastic member 110 may be modified, in accordance with embodiments of the disclosure, to provide the desired retracting force.

Additionally, in some embodiments, at least one peripheral portion of the plurality of peripheral portions 105a, 105b, 105c may include a support surface 108a, 108b, 108c extending from the inner surface 106a, 106b, 106c in the inner direction 306a, 306b, 306c. In some embodiments, the support surface 108a, 108b, 108c of the at least one peripheral portion of the plurality of peripheral portions 105a, 105b, 105c may support at least a portion of the first major surface 121 of the glass sheet 120. In some embodiments, the glass sheet 120 may be disposed in the retaining area 125 with at least a portion of the second major surface 122 of the glass sheet 120 (e.g., exposed area 101 shown in FIGS. 6-9) exposed for a processing technique. Accordingly, in some embodiments, the glass sheet 120 may be disposed in the retaining area 125 with at least a portion of the edge 123 of the glass sheet 120 isolated from the exposed area 101 (see FIGS. 6-9) of the second major surface 122 of the glass sheet 120.

In some embodiments, the support surfaces 108a, 108b, 108c of the plurality of peripheral portions 105a, 105b, 105c of the base 105 may support at least a portion of the first major surface 121 of the glass sheet 120 by contacting at least a portion of the first major surface 121 of the glass sheet 120. Alternatively, in some embodiments, a sheet of protective material (e.g., a sheet of glassine paper, a coating of material, etc.) may be positioned between the support surfaces 108a, 108b, 108c and the first major surface 121 of the glass sheet 120 to help protect the first major surface 121 from being scratched or otherwise damaged by the base 105. Supporting the glass sheet 120 with the support surfaces 108a, 108b, 108c of the plurality of peripheral portions 105a, 105b, 105c of the base 105 may provide a structure to which the glass sheet 120 may be secured for further processing while distributing supportive force across the first major surface 121 of the glass sheet 120 to reduce stress concentrations in the glass sheet 120. In addition, the support surfaces 108a, 108b, 108c may isolate at least a portion of the glass sheet 120 (e.g., the first major surface 121) from the exposed area 101 of the second major surface 122 of the glass sheet 120. For example, the inner surfaces 106a, 106b, 106c may isolate at least a portion of the edge 123 of the glass sheet 120, and the support surfaces 108a, 108b, 108c which extend from the inner surfaces 106a, 106b, 106c may cooperate with the inner surfaces 106a, 106b, 106c to isolate at least the portion of the edge 123 of the glass sheet 120 as well as to isolate at least a portion of the first major surface 121 of the glass sheet 120. Likewise, the base 105 may provide a structure by which the carrier apparatus 100 including the glass sheet 120 may be attached to one or more additional structures for at least one of processing, storage, and transportation. When the base 105 is attached to one or more additional structures, the one or more additional structures either alone or in combination with the base 105 may isolate the first major surface 121 (e.g., at least a portion of the first major surface 121, or the entire first major surface 121) of the glass sheet 120 from the environment to which the exposed area 101 of the second major surface 122 is exposed. In some embodiments, the base 105 may also protect the glass sheet 120 from mechanical shock, vibrations, and other external forces to which the carrier apparatus 100 may be subjected.

In some embodiments, the base 105 may be solid (e.g., entirely solid); however, in some embodiments, the base 105 may be hollow, include apertures, or include a network of at least one of solid structures and hollow structures connected together with spaces between the at least one of the solid structures and the hollow structures. In some embodiments, solid support surfaces 108a, 108b, 108c may isolate the first major surface 121 of the glass sheet 120 from the exposed area 101 of the second major surface 122 of the glass sheet 120; whereas, a base 105 including a network of at least one of solid structures and hollow structures connected together with spaces between the at least one of the solid structures and the hollow structures may expose the first major surface 121 of the glass sheet 120 to the same environment to which the exposed area 101 of the second major surface 122 of the glass sheet 120 is exposed. Thus, in some embodiments, the base 105 may be mounted to a structure to isolate the first major surface 121 of the glass sheet 120 from the exposed area 101 of the second major surface 122 of the glass sheet 120. Additionally, in some embodiments, a hollow base 105 or a base 105 including a network of at least one of solid structures and hollow structures connected together with spaces between the at least one of the solid structures and the hollow structures may be lighter than, for example, a solid base 105, and therefore may include less material, be less expensive to manufacture, and provide additional advantages when employed in accordance with embodiments of the disclosure. In some embodiments, as mentioned above, the support surfaces 108a, 108b, 108c of the plurality of peripheral portions 105a, 105b, 105c of the base 105 may include one or more of a liner (e.g., scratch resistant paper), protrusions, and surface coating to prevent the support surfaces 108a, 108b, 108c from scratching and abrading the first major surface 121 of the glass sheet 120 when the support surfaces 108a, 108b, 108c support the first major surface 121 of the glass sheet 120.

In some embodiments, the carrier apparatus 100 may include an adapter ring 115 (e.g., the illustrated continuous endless loop adapter ring 115) positioned between the inner surfaces 106a, 106b, 106c of at least one peripheral portion of the plurality of peripheral portions 105a, 105b, 105c and the edge 123 of the glass sheet 120. In some embodiments, the adapter ring 115 may define a dimension of the retaining area 125; and, in the retracted position, the adapter ring 115 may secure the glass sheet 120 in the retaining area 125. For example, in some embodiments, the adapter ring 115 may include an inner surface 116 that abuts at least a portion of the edge 123 of the glass sheet 120, and on outer surface 117 that abuts at least a portion of the inner surface 106a, 106b, 106c of each peripheral portion of the plurality of peripheral portions 105a, 105b, 105c. Although illustrated as a circular adapter ring 115, unless otherwise noted, in some embodiments, the carrier apparatus 100 may be modified, in accordance with features of the disclosure, to include an adapter ring 115 having a shape and size different from the illustrated adapter ring 115, without departing from the scope of the disclosure. For example, in some embodiments, the adapter ring 115 may define a dimension of the retaining area 125 having a rectangular shape, an oval shape, a square shape, a trapezoidal shape, a parallelogram shape, or other shape. Accordingly, in some embodiments, the adapter ring 115 may be employed to, for example, accommodate glass sheets having different dimensions, shapes, and sizes. In some embodiments, an adapter ring 115 defining a predetermined dimension of the retaining area 125 may be selected based at least on a corresponding dimension of the glass sheet 120 to be secured in the retaining area 125. In some embodiments, the adapter ring 115 may therefore provide a more universal carrier apparatus 100, features and components of which may be universally employed to secure a variety of glass sheets having a range of dimensions. Additionally, in some embodiments, the adapter ring 115 may be optional, and at least a portion of the inner surface 106a, 106b, 106c of each peripheral portion of the plurality of peripheral portions 105a, 105b, 105c may therefore abut the edge 123 of the glass sheet 120 to secure the glass sheet 120 in the retaining area 125. Providing the carrier apparatus 100 with one or more components that are at least one of reusable and interchangeable may permit repeated use of one or more components of the carrier apparatus 100, thereby reducing costs, improving allocation of materials and resources, and increasing efficiency.

Once assembled, the carrier apparatus 100 including the glass sheet 120 may then be processed to, for example, deposit a material on the exposed area 101 of the second major surface 122 of the glass sheet 120. In some embodiments, the deposited material may provide an abrasion and scratch resistant coating on the glass sheet 120 and may increase strength of the glass sheet 120 to prevent breakage of the glass sheet 120. Some glass coating deposition technologies include at least one of physical, plasma, and chemical vapor deposition that provides a coating on the glass sheet 120. These processes of depositing a material on the glass sheet 120 may include handling and transport of the carrier apparatus 100 including the glass sheet 120. The surface coatings may be optically transparent so as to provide minimal to no interference with or distortion of images that may be displayed on or viewed through the glass sheet 120. Moreover, during a coating process, it may be desirable that the material deposited on the glass sheet 120 be deposited only on, for example, the major surface with which a user may interact. For example, the glass sheet 120 may be provided in a touch-screen application where a user may physically contact a major surface of the glass sheet 120 to control features of a display device. Likewise, the glass sheet 120 may be provided in an application where a major surface of the glass sheet 120 may be provided for viewing by a user and may, therefore, be exposed to the environment including dust, debris, and other objects that may scratch and abrade the major surface of the glass sheet 120. The carrier apparatus 100 including the glass sheet 120 may therefore secure the glass sheet 120 and facilitate handling and transport of the glass sheet 120 during processing in a manner that exposes the exposed area 101 of the second major surface 122 of the glass sheet 120 to be coated while isolating the edge 123 of the glass sheet 120 and the opposing first major surface 121 of the glass sheet 120 from the same environment as the exposed area 101 of the second major surface 122 of the glass sheet 120.

Isolating one or more of a portion of the edge 123 of the glass sheet 120, the entire edge 123 of the glass sheet 120, a portion of the second major surface 122 of the glass sheet 120, and the first major surface 121 of the glass sheet 120 from the same environment as the exposed area 101 of the second major surface 122 of the glass sheet 120 may provide several advantages. The advantages will be described with respect to isolating at least a portion of the edge 123 of the glass sheet 120 with the understanding that the same or similar advantages may be achieved by isolating the entire edge 123 of the glass sheet 120, by isolating a portion of the second major surface 122 of the glass sheet 120, and by isolating the first major surface 121 of the glass sheet 120. In addition, the advantages may apply equally to a glass sheet including a planar portion (e.g., a 2D glass sheet) as well as a glass sheet including a non-planar portion (e.g., a 3D glass sheet).

For example, in some embodiments, isolating at least a portion of the edge 123 of the glass sheet 120 from the exposed area 101 of the second major surface 122 of the glass sheet 120 may provide several advantages including, but not limited to, isolating the portion of the edge 123 of the glass sheet 120 from material that may be deposited on the exposed area 101 of the second major surface 122 of the glass sheet 120. That is, in some embodiments, material deposited on the exposed area 101 of the second major surface 122 off the glass sheet 120 may be prevented from at least one of contacting and adhering to the portion of the edge 123 of the glass sheet 120 based at least in part on the adapter ring 115 isolating the portion of the edge 123 of the glass sheet 120 from the exposed area 101 of the second major surface 122 of the glass sheet 120. In some embodiments, preventing material from at least one of contacting and adhering to the portion of the edge 123 of the glass sheet 120 may ensure that a predetermined dimensional size of the glass sheet 120 remains unchanged during subsequent processing. For example, in some embodiments, the glass sheet 120 may be employed in a particular application where a particular predetermined dimensional size of the glass sheet 120 is desired. By isolating at least a portion of the edge 123 of the glass sheet 120 from the exposed area 101 of the second major surface 122 of the glass sheet 120, material deposited on the exposed area 101 of the second major surface 122 of the glass sheet 120, which may increase a dimension (e.g., along the thickness “t’) of the glass sheet 120 is prevented from increasing a dimension of the edge 123 of the glass sheet 120 based at least in part on the plurality of peripheral portions 105a, 105b, 105c of the base 105 (and, when employed, the adapter ring 115) isolating at least a portion of the edge 123 of the glass sheet 120.

Additionally, in some embodiments, isolating the portion of the edge 123 of the glass sheet 120 from the exposed area 101 of the second major surface 122 of the glass sheet 120, thereby preventing material from at least one of contacting and adhering to the portion of the edge 123 of the glass sheet 120, may provide improved optical characteristics of the glass sheet 120. For example, in some embodiments, material deposited on the exposed area 101 of the second major surface 122 of the glass sheet 120 may reduce, degrade, or interfere with an optical characteristic of the glass sheet 120. For example, in some embodiments, material deposited on the exposed area 101 of the second major surface 122 of the glass sheet 120 may include optical properties that differ from the optical properties of the glass sheet 120. In some embodiments, the glass sheet 120 may provide desirable optical clarity for a particular display application, and it may, therefore, be desirable to limit the amount of material deposited on the glass sheet 120. However, depositing material on the glass sheet 120 may, for example, provide a scratch resistant coating and increase the strength of the glass sheet 120, in some embodiments. Accordingly, by depositing material on the exposed area 101 of the second major surface 122 of the glass sheet 120 (e.g., only on the exposed area 101 of the second major surface 122 of the glass sheet 120) while isolating at least a portion of the edge 123 of the glass sheet 120 as well as isolating the first major surface 121 of the glass sheet 120 from the same environment as the exposed area 101 of the second major surface 122 of the glass sheet 120, the glass sheet 120 may include the scratch resistant coating and exhibit increased strength without altering the optical properties of the edge 123 of the glass sheet 120 and the first major surface 121 of the glass sheet 120.

Likewise, in some embodiments, isolating the portion of the edge 123 of the glass sheet 120 from the exposed area 101 of the second major surface 122 of the glass sheet 120, thereby preventing material from at least one of contacting and adhering to the portion of the edge 123 of the glass sheet 120, may provide a stronger edge 123 of the glass sheet 120 than, for example, an edge 123 of the glass sheet 120 to which material has adhered. For example, in some embodiments, the material may impart a stress on the edge 123 of the glass sheet 120, whereby such stress may be reduced or eliminated by isolating at least a portion of the edge 123 of the glass sheet 120.

Moreover, in some embodiments, features of the disclosure may be employed without adhesives because the elastic member 110 may provide a retracting force to secure the glass sheet 120 in the retaining area 125 of the base 105. Consequently, some embodiments of the disclosure may be employed without subsequent steps to remove adhesive, for example, from the first major surface 121 of the glass sheet 120. As provided, features of the disclosure secure the glass sheet 120 to the base 105 while isolating the edge 123 of the glass sheet 120. In addition, features of the disclosure including, but not limited to, the base 105, the elastic member 110, and the adapter ring 115 may be reusable; whereas, conventional attachment configurations may only provide for a single use and must be disposed of after each use. Accordingly, the carrier apparatus 100 of the present disclosure may provide a less expensive and more efficient method of securing a glass sheet 120. Features of the present disclosure therefore provide several advantages over known methods of securing a glass sheet.

In some embodiments, a method of using the carrier apparatus 100 may include processing the exposed area 101 of the second major surface 122 of the glass sheet 120 while the glass sheet 120 is disposed in the retaining area 125. The method may include applying a retracting force (e.g., along one or more of directions 306a, 306b, and 306c, shown in FIG. 3) to the plurality of peripheral portions 105a, 105b, 105c of the base 105 to bias each peripheral portion of the plurality of peripheral portions 105a, 105b, 105c into the retracted position with the inner surfaces 106a, 106b, 106c of each peripheral portion of the plurality of peripheral portions 105a, 105b, 105c cooperating to entirely circumscribe the retaining area 125 including an opening 125a (shown in FIG. 3) into the retaining area 125. As provided above, in some embodiments, the elastic member 110 may provide the retracting force to bias each peripheral portion of the plurality of peripheral portions 105a, 105b, 105c into the retracted position.

In some embodiments, the method may include opposing the retracting force (e.g., along one or more of directions 307a, 307b, and 307c, shown in FIG. 4) of at least one peripheral portion of the plurality of peripheral portions 105a, 105b, 105c to move the at least one peripheral portion into the extended position to enlarge the opening 125a and provide an enlarged opening 125b (shown in FIG. 4) into the retaining area 125. In some embodiments, the method may include engaging the base 105 with a tool 400 to oppose the retracting force and move the at least one peripheral portion of the plurality of peripheral portions 105a, 105b, 105c into the extended position. For example, in some embodiments the tool 400 may engage one or more corresponding contact surfaces 109a, 109b, 109c of the plurality of peripheral portions 105a, 105b, 105c to oppose the retracting force. In some embodiments, the one or more contact surfaces 109a, 109b, 109c of the plurality of peripheral portions 105a, 105b, 105c may include one or more protrusions, recesses, reliefs, or other feature with which the tool 400 may be oriented to engage. In some embodiments, the method may further include placing the glass sheet 120 within the enlarged opening 125b while opposing the retracting force. Additionally, in some embodiments, after placing the glass sheet 120 within the enlarged opening 125b, the method may include ceasing to oppose the retracting force such that the at least one peripheral portion of the plurality of peripheral portions 105a, 105b, 105c moves into the retracted position (e.g., based at least in part on the retracting force) applied by the elastic member 110, thereby securing the glass sheet 120 within the retaining area 125. In some embodiments, the method may then include processing the exposed area 101 of the second major surface 122 of the glass sheet 120 while the glass sheet 120 is secured within the retaining area 125. Moreover, after processing the exposed area 101 of the second major surface 122 of the glass sheet 120, the method may include enlarging the opening 125a into the retaining area 125 to provide the enlarged opening 125b, and then removing the glass sheet 120 from the enlarged opening 125b.

Features of the disclosure may therefore provide an apparatus and methods for at least one of securing a glass sheet 120 and processing a carrier apparatus 100 including the glass sheet 120 that may be at least partially, and in some embodiments, fully automated. For example, in some embodiments, methods of the disclosure may be employed with little to no human interaction. In some embodiments, the tool 400 may be provided to operate (e.g., based on mechanical movement, pneumatic movement, servo movement, electro-mechanical movement etc., not shown) to oppose the retracting force being applied by the elastic member 110 and move the at least one peripheral portion of the plurality of peripheral portions 105a, 105b, 105c into the extended position. Likewise, a vacuum device (e.g., Bernoulli chuck, not shown) may be provided to pick and place the glass sheet 120 within the enlarged opening 125b while opposing the retracting force. The tool 400 may then be operated to cease opposing the retracting force such that the at least one peripheral portion of the plurality of peripheral portions 105a, 105b, 105c moves again into the retracted position under the retracting force being applied by the elastic member 110, thereby securing the glass sheet 120 within the retaining area 125. After processing the exposed area 101 of the second major surface 122 of the glass sheet 120, for example, the tool 400 may be operated to again oppose the retracting force, thereby enlarging the opening 125a into the retaining area 125 to provide the enlarged opening 125b. Furthermore, the vacuum device may then be operated to remove the glass sheet 120 from the enlarged opening 125b. By automating one or more features of the disclosure, methods and apparatus of the disclosure may be employed in an efficient, reliable, and reproducible manner that may reduce or eliminate potential human error.

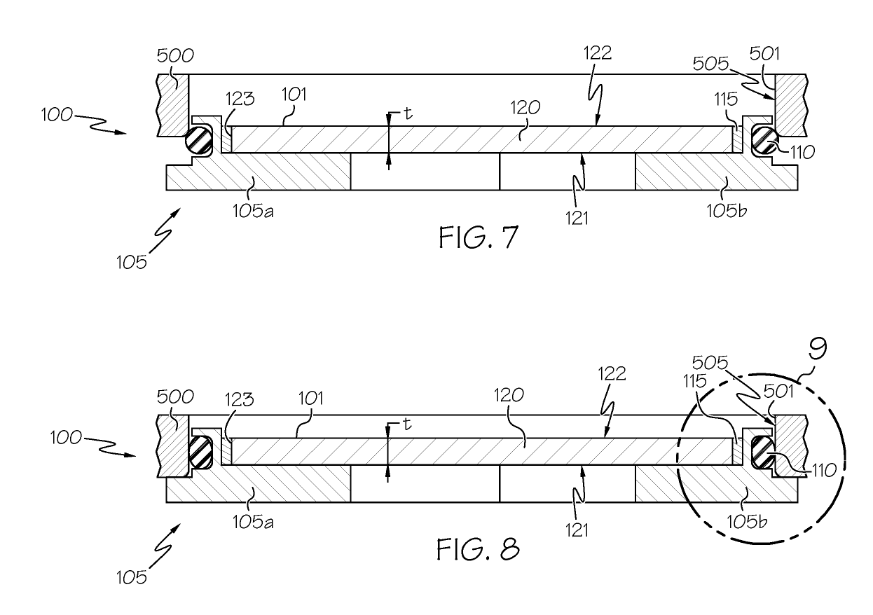

Additionally, features of the disclosure may be employed to secure a plurality of glass sheets. For example, in some embodiments, a plurality of carrier apparatus 100 including a corresponding plurality of glass sheets may be processed in accordance with embodiments of the disclosure. As shown in FIG. 5, in some embodiments, a fixture 500 may include a cavity 501 to receive one or more carrier apparatus 100. As shown in FIGS. 6-8, which illustrate a partial cross-sectional view of the fixture 500 along line 6-6 of FIG. 5, in some embodiments, an inner peripheral surface 505 of the cavity 501 of the fixture 500 may compress the elastic member 110 to secure the carrier apparatus 100 to the fixture 500. For example, FIG. 6 shows a cross-sectional view of the fixture 500 including the carrier apparatus 100 and the glass sheet 120 with the carrier apparatus 100 separated from the fixture 500. In some embodiments, an inner dimension “d1” of the cavity 501 of the fixture 500 may be less than a corresponding outer dimension “d2” of the carrier apparatus 100 (e.g., an outer dimension of the elastic member 110. Accordingly, as shown in FIG. 7 with the carrier apparatus 100 partially received in the cavity 501 of the fixture 500, as the inner peripheral surface 505 of the cavity 501 contacts the elastic member 110, the elastic member 110 may begin to deform. Furthermore, as shown in FIG. 8 with the carrier apparatus 100 received in the cavity 501 of the fixture 500, the inner peripheral surface 505 of the cavity 501 may compress the elastic member 110 to secure the carrier apparatus 100 to the fixture 500. In some embodiments, a relative motion between the carrier apparatus 100 and the fixture 500 may be provided for the fixture 500 to receive the carrier apparatus 100 in the cavity 501 of the fixture 500.

Accordingly, in addition to providing a structure that may accommodate a plurality of carrier apparatus 100, the fixture 500 may also help maintain the carrier apparatus 100 in the retracted position by compressing the elastic member 110 and resisting or preventing movement of one or more of the plurality of peripheral portions 105a, 105b, 105c in a direction that may otherwise oppose the retracting force. In some embodiments, based at least on the compression of the elastic member 110, when the carrier apparatus 100 is received in the cavity 501 of the fixture 500, the fixture 500 may also increase the retracting force to further secure the glass sheet 120 within the retaining area of the base 105.

FIG. 9 shows an enlarged view of a portion of the cross-sectional view of the fixture 500 including the carrier apparatus 100 and the glass sheet 120 taken at view 9 of FIG. 8 with the carrier apparatus 100 received in the cavity 501 of the fixture 500. While the view illustrated in FIG. 9 shows a portion of the third peripheral portion 105c of the base 105, unless otherwise noted, the features may apply equally to the first peripheral portion 105a and the second peripheral portion 105b without departing from the scope of the disclosure. As shown, the elastic member 110 may be seated within the groove 905 of the outer surface 107c of the third peripheral portion 105c of the base 105. Additionally, the inner peripheral surface 505 of the cavity 501 may compress the elastic member 110 to secure the carrier apparatus 100 to the fixture 500. The outer surface 117 of the adapter ring 115 may abut the inner surface 106c of the third peripheral portion 105c, and the inner surface 116 of the adapter ring 115 may abut the edge 123 of the glass sheet 120. The support surface 108c of the third peripheral portion 105c may support the first major surface 121 of the glass sheet 120. Further, the exposed area 101 of the second major surface 122 of the glass sheet 120 may be exposed for a processing technique.

Unless otherwise noted, in some embodiments, the inner surface 106c of the third peripheral portion 105c of the base 105 may be modified, in accordance with embodiments of the disclosure, to include one or more features of the adapter ring 115, including the protrusion 901, without departing from the scope of the disclosure. For example, in embodiments where the adapter ring 115 is not provided, the inner surface 106c of the third peripheral portion 105c of the base 105 may include features of the adapter ring 115 and may therefore provide the same or similar advantages as the adapter ring 115. Therefore, although described with respect to the adapter ring 115, features of the adapter ring 115 may apply equally to the inner surface 106c of the third peripheral portion 105c of the base 105, in some embodiments.

In some embodiments, the adapter ring 115 may include a profile that conforms to a shape of the edge 123 of the glass sheet 120. In some embodiments, the adapter ring 115 may include one or more of an elastically deformed portion, a plastically deformed portion, and a preformed portion that may conform to a shape of the edge 123 of the glass sheet 120 to thereby provide a seal against the glass sheet 120 to isolate at least a portion of the edge 123 of the glass sheet 120. For example, in some embodiments, the adapter ring 115 may be formed (e.g., stamped, pressed, bent) to plastically deform at least a portion of the adapter ring 115 to include a profile that conforms to a shape of the edge 123 of the glass sheet 120. Additionally, in some embodiments, the adapter ring 115 may be manufactured (e.g., extruded, molded, injection molded, vacuum formed, cast) to preform at least a portion of the adapter ring 115 to include a profile that conforms to a shape of the edge 123 of the glass sheet 120. Likewise, in some embodiments, the adapter ring 115 may be manufactured from a resilient material (e.g., elastomeric material, polymeric material) that, when contacted by the edge 123 of the glass sheet 120, may deform to include a profile that conforms to a shape of the edge 123 of the glass sheet 120. In some embodiments, the profile of the adapter ring 115 may include a concave profile, a convex profile, a stepped profile, an angled profile, or other shaped profile defining at least a portion of the inner surface 116 of the adapter ring 115.

In some embodiments, the adapter ring 115 may include an optional protrusion 901 that extends from the inner surface 116 of the adapter ring 115. For example, in some embodiments, the protrusion 901 may extend onto (e.g., physically contact) a portion of the second major surface 122 of the glass sheet 120. Alternatively, in some embodiments, the protrusion 901 may extend over (e.g., without physically contacting) a portion of the second major surface 122 of the glass sheet 120. In some embodiments, the protrusion 901 may isolate a portion of the second major surface 122 of the glass sheet 120 from the exposed area 101 of the second major surface 122 of the glass sheet 120. Unless otherwise noted, the exposed area 101 of the second major surface 122 of the glass sheet 120 may include the entire second major surface 122 of the glass sheet 120. However, in some embodiments, in order to isolate at least a portion of the edge 123 of the glass sheet 120, the adapter ring 115 may at least one of extend onto and extend over a portion of the second major surface 122 of the glass sheet 120, thereby isolating the portion of the second major surface 122 of the glass sheet 120. In some embodiments, the isolated portion of the second major surface 122 of the glass sheet 120 may be defined as an outermost portion of the second major surface 122 of the glass sheet 120 between the edge 123 of the glass sheet 120 and the exposed area 101 of the second major surface 122 of the glass sheet 120 that circumscribes the exposed area 101 of the second major surface 122 of the glass sheet 120.

Accordingly, in some embodiments, a portion of the edge 123 of the glass sheet 120 may be isolated (e.g., by at least one of the adapter ring 115 and the base 105) from the exposed area 101 of the second major surface 122 of the glass sheet 120. Likewise, in some embodiments, the entire edge 123 of the glass sheet 120 may be isolated from the exposed area 101 of the second major surface 122 of the glass sheet 120. Moreover, in some embodiments, a portion of the second major surface 122 of the glass sheet 120 may be isolated (e.g., by the protrusion 901 of the adapter ring 115) from the exposed area 101 of the second major surface 122 of the glass sheet 120. Furthermore, in some embodiments, the base 105, alone or in combination with the adapter ring 115 may isolate the first major surface 121 (e.g., at least one of a portion of the first major surface 121 and the entire first major surface 121) of the glass sheet 120 from the same environment as the exposed area 101 of the second major surface 122 of the glass sheet 120. In some embodiments, the base 105 and the adapter ring 115 may be impermeable to matter including solid matter, and fluid (e.g., liquid, gas) matter, thereby isolating one or more of a portion of the edge 123 of the glass sheet 120, the entire edge 123 of the glass sheet 120, and a portion of the second major surface 122 of the glass sheet 120 from the exposed area 101 of the second major surface 122 of the glass sheet 120 from such matter.

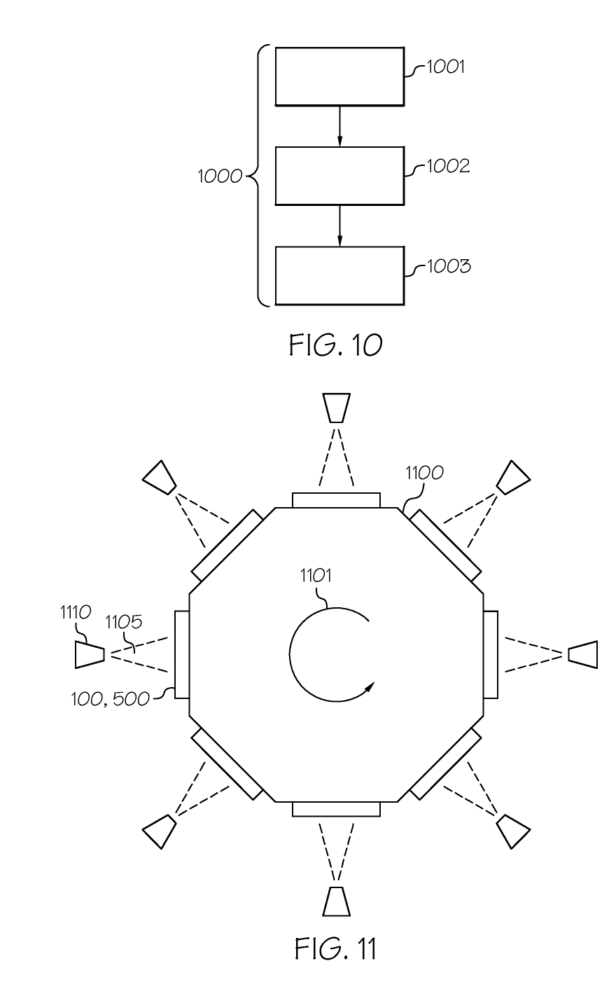

Referring to FIG. 10, in some embodiments, a method of processing 1000 the carrier apparatus 100 and/or the fixture 500 including one or more carrier apparatus 100 may include providing (represented schematically by step 1001) the assembled carrier apparatus 100 and the assembled fixture 500 including one or more glass sheets 120. The method may include coating the exposed area 101 of the second major surface 122 of the glass sheet 120 with a coating material (represented schematically by step 1003). In some embodiments, the method may include placing the carrier apparatus 100 and the fixture 500 in a vacuum enclosure and drawing a vacuum on the carrier apparatus 100 and the fixture 500 within the vacuum enclosure (represented schematically by step 1002) prior to coating the exposed area 101 of the second major surface 122 of the glass sheet 120 with the coating material. In some embodiments, drawing a vacuum on the carrier apparatus 100 and the fixture 500 may remove fluid (e.g. liquid, gas) contained on or within one or more components of the carrier apparatus 100 and the fixture 500. For example, in some embodiments, drawing a vacuum on the carrier apparatus 100 and the fixture 500 prior to coating the exposed area 101 of the second major surface 122 of the glass sheet 120 with the coating material may prevent one or more components of the carrier apparatus 100 and the fixture 500 from degassing and contaminating the glass sheet 120 during subsequent processing including, but not limited to, the coating process.

For example, as illustrated in FIG. 11, in some embodiments, the method may include fixing the carrier apparatus 100 and/or the fixture 500 to a rotatable drum 1100, and then rotating the rotatable drum 1100 (e.g., as shown by arrow 1101) while coating the exposed area 101 of the second major surface 122 of the glass sheet 120 with coating material. For example, in some embodiments, one or more outlets 1110 (e.g., nozzles, orifices, sprayers, jets, etc.) may be provided to spray (or otherwise deposit) a coating material 1105 onto the exposed area 101 of the second major surface 122 of the glass sheet 120 while the rotatable drum 1100 is rotating as indicated at 1101. In some embodiments (not shown), other coating application techniques including, but not limited to, linear or conveyance processing, PVD, CVD, and/or PECVD, may be employed to coat (or otherwise deposit) the coating material 1105 onto the exposed area 101 of the second major surface 122 of the glass sheet 120.

Additionally, in some embodiments, one or more of the outlets 1110 may be provided at an angle relative to the second major surface 122 of the glass sheet 120 to spray the coating material 1105 onto the exposed area 101 of the second major surface 122 of the glass sheet 120. For example, as shown, in some embodiments, one or more of the outlets 1110 may be provided at a 90-degree angle relative to the second major surface 122 of the glass sheet 120 such that the one or more outlets 1110 are perpendicular to the second major surface 122 of the glass sheet 120 to spray the coating material 1105 onto the exposed area 101. Likewise, in some embodiments, one or more of the outlets 1110 may be provided at one or more angles (e.g., 15 degrees, 30, degrees, 45 degrees, etc.) relative to the second major surface 122 of the glass sheet 120 such that the one or more outlets 1110 are not perpendicular and are angled relative to the second major surface 122 of the glass sheet 120 to spray the coating material 1105 onto the exposed area 101. In some embodiments, providing one or more of the outlets 1110 at one or more non-perpendicular angles relative to the second major surface 122 of the glass sheet 120 may provide at least one of better coverage and a more uniform coating of the coating material 1105 onto the exposed area 101 of the second major surface 122 of the glass sheet 120 than, for example, providing one or more of the outlets 1110 at a 90-degree angle relative to the second major surface 122 of the glass sheet 120. For example, in some embodiments, while the rotatable drum 1100 is rotating as indicated at 1101, providing one or more of the outlets 1110 at one or more non-perpendicular angles relative to the second major surface 122 of the glass sheet 120 may provide at least one of better coverage and a more uniform coating of the coating material 1105 onto the exposed area 101 of the second major surface 122 of the glass sheet 120.

The carrier apparatus 100 including the glass sheet 120 as well as the fixture 500 may secure carrier apparatus 100 and the glass sheet 120 during the coating processes thereby resisting forces, including but not limited to, counter forces, centrifugal forces, gravity, and inertia which may tend to separate the glass sheet 120 from the base 105. For example, in some embodiments, while rotating, the rotatable drum 1100 may exert a centrifugal force on the glass sheet 120 exceeding, for example, ten times the force of gravity (e.g., 10 g's) or twenty times the force of gravity (e.g., 20 g's). Accordingly, features of the disclosure may secure the glass sheet 120 to the base 105 with the elastic member 110 providing a retracting force sufficient to secure the glass sheet 120 against centrifugal forces in excess of 10 g's or 20 g's, in some embodiments.

Directional terms as used herein—for example up, down, right, left, front, back, top, bottom—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

The above embodiments, and the features of those embodiments, are exemplary and may be provided alone or in any combination with any one or more features of other embodiments provided herein without departing from the scope of the disclosure.

It will be apparent to those skilled in the art that various modifications and variations may be made to the present disclosure without departing from the spirit and scope of the disclosure. Thus, it is intended that the present disclosure cover the modifications and variations of this disclosure provided they come within the scope of the appended claims and their equivalents.

1. A carrier apparatus comprising:
a base comprising a plurality of peripheral portions, each peripheral portion of the plurality of peripheral portions comprising an inner surface facing an inner direction, at least one peripheral portion of the plurality of peripheral portions selectively moveable between an extended position and a retracted position; and
an elastic member to bias the at least one peripheral portion of the plurality of peripheral portions into the retracted position such that the inner surfaces of the plurality of peripheral portions cooperate to circumscribe a retaining area.

2. The carrier apparatus of claim 1, the elastic member comprising an endless loop.

3. The carrier apparatus of claim 1, at least one peripheral portion of the plurality of peripheral portions comprising a support surface extending from the inner surface in the inner direction.

4. The carrier apparatus of claim 1, each peripheral portion of the plurality of peripheral portions comprising a first engagement surface and a second engagement surface, the first engagement surface and the second engagement surface of each peripheral portion of the plurality of peripheral portions engaging a corresponding engagement surface of an adjacent peripheral portion of the plurality of peripheral portions when the plurality of peripheral portions are in the retracted position.

5. The carrier apparatus of claim 1, at least one peripheral portion of the plurality of peripheral portions comprising an outer surface, and the elastic member engaging the outer surface of the at least one peripheral portion of the plurality of peripheral portions.

6. The carrier apparatus of claim 1, each peripheral portion of the plurality of peripheral portions comprising an outer surface, and the elastic member simultaneously engaging the outer surface of each peripheral portion of the plurality of peripheral portions, the outer surface of each peripheral portion of the plurality of peripheral portions comprising a groove, and the elastic member seated within the groove of each peripheral portion of the plurality of peripheral portions.

7. A fixture comprising a cavity to receive the carrier apparatus of claim 1, an inner peripheral surface of the cavity of the fixture compressing the elastic member to secure the carrier apparatus to the fixture.

8. The carrier apparatus of claim 1, further comprising an article disposed in the retaining area, the article comprising a first major surface, a second major surface, a thickness between the first major surface and the second major surface, and an edge extending across the thickness between the first major surface and the second major surface; in the retracted position, the inner surfaces of the plurality of peripheral portions cooperate to circumscribe the edge of the article.

9. The carrier apparatus of claim 8, at least one peripheral portion of the plurality of peripheral portions comprising a support surface extending from the inner surface in the inner direction, and the support surface of the at least one peripheral portion of the plurality of peripheral portions supporting the first major surface of the article.

10. The carrier apparatus of claim 8, the article disposed in the retaining area with at least a portion of the second major surface of the article exposed for a processing technique.

11. The carrier apparatus of claim 10, the article disposed in the retaining area with at least a portion of the edge of the article isolated from the exposed portion of the second major surface of the article.

12. The carrier apparatus of claim 10, the article disposed in the retaining area with at least a portion of the second major surface of the article isolated from the exposed portion of the second major surface of the article.

13. The carrier apparatus of claim 8, further comprising an adapter ring positioned between the inner surface of at least one peripheral portion of the plurality of peripheral portions and the edge of the article.

14. The carrier apparatus of claim 8, the elastic member biases at least one peripheral portion of the plurality of peripheral portions into the retracted position, the plurality of peripheral portions cooperate to hold the article.

15. The carrier apparatus of claim 8, the article comprising a sheet comprising glass, glass-ceramic, ceramic, or combinations thereof.

16. A fixture comprising a cavity receiving the carrier apparatus of claim 8, an inner peripheral surface of the cavity of the fixture compressing the elastic member to secure the carrier apparatus to the fixture.

17-24. (canceled)
